(19) United States
(12) Patent Application Publication
(10) Pub. No.: US 2023/0415099 A1
(43) Pub. Date: Dec. 28, 2023

(54) METHOD OF EVALUATING SEPARATION MEMBRANE MODULE

(71) Applicant: NGK INSULATORS, LTD., Nagoya-City (JP)

(72) Inventors: Katsuya SHIMIZU, Kasugai-City (JP); Makiko ICHIKAWA, Nagoya-City (JP); Kenichi NODA, Nagoya-City (JP); Naoto KINOSHITA, Nagoya-City (JP)

(73) Assignee: NGK INSULATORS, LTD., Nagoya-City (JP)

(21) Appl. No.: 18/466,113

(22) Filed: Sep. 13, 2023

Related U.S. Application Data
(63) Continuation of application No. PCT/JP2021/042192, filed on Nov. 17, 2021.

(30) Foreign Application Priority Data
Mar. 30, 2021 (JP) 2021-056936

(51) Int. Cl. B01D 65/10; B01D 71/02

(52) U.S. Cl. CPC B01D 65/102; B01D 65/104; B01D 71/0281

(57) ABSTRACT

A method of evaluating a separation membrane module includes a step of supplying a performance degradation gas having a property of reducing permeance of a separation membrane to a primary side of the separation membrane, and a step of, after the previous step, supplying an evaluation fluid to the primary side of the separation membrane to measure a flow rate of the evaluation fluid to a secondary side of the separation membrane.

### CROSS-REFERENCE TO RELATED APPLICATION

The present application is a continuation application of International Application No. PCT/JP2021/042192 filed on Nov. 17, 2021, which claims the benefit of priority to Japanese Patent Application No. 2021-056936 filed on Mar. 30, 2021. The entire contents of these applications are incorporated herein by reference.

### TECHNICAL FIELD

The present invention relates to a method of evaluating a separation membrane module.

### BACKGROUND ART

Various studies and developments are currently underway on processing such as separation or adsorption of specific molecules via a separation membrane such as a zeolite membrane.

For example, International Publication No. 2018/180095 (Document 1) discloses a separation membrane module in which a separation membrane structure that includes a zeolite membrane provided on a porous base material is incorporated into a casing. Such a separation module has properties that are determined by, for example, performance of a zeolite membrane and the amount of leak from defects existing in the zeolite membrane and a sealer that provides sealing between the casing and the separation membrane structure. Document 1 proposes a technique for conducting a leak inspection on a separation membrane module while suppressing degradation of permeability of the zeolite membrane by increasing the dynamic molecular size of an inspection gas to be more than 1.07 times of the pore size of the zeolite membrane.

International Publication No. 2018/179959 (Document 2) proposes a technique for, in the case of conducting a leak inspection on a separation membrane module as described above, suppressing a reduction in the permeance of a zeolite membrane before and after the inspection by using an inspection liquid such as Fluorinert (registered trademark) whose molecular size is greater than the pore size of the zeolite membrane.

In the leak inspection according to Document 1 or 2, the amount of the inspection gas or the inspection liquid that has permeated through (i.e., leaked from) the defects in the sealer can be accurately measured because the inspection gas or the inspection liquid is prevented from permeating through the zeolite membrane.

Meanwhile, Japanese Patent Application Laid-Open No. 2021-023898 (Document 3) proposes a technique for wetting a tubular separation membrane by supplying and discharging a liquid to and from a housing that houses therein the tubular separation membrane before execution of a leak inspection of the tubular separation membrane. This technique reduces the amount of gas permeating through small pores of the tubular separation membrane and improves the accuracy of determining the presence or absence of a leak.

According to Document 1 or 2, since a substance with a relatively large molecular size (e.g., CF₄ or Fluorinert) is used as the inspection gas or the inspection liquid, it is difficult to detect the defects smaller than the molecular size of this substance, if there are the defects in the sealer or any other component in the separation membrane module. There is thus a limit to improving the accuracy of evaluating characteristics of the separation membrane module. Besides, since the inspection gas or the inspection liquid is limited to a substance such as CF₄ or Fluorinert that has high warming potential, concerns arise about environmental burdens that may be imposed by the discharge of the inspection gas or the inspection liquid or cost burdens that may be imposed by collection of the inspection gas or the inspection liquid.

Moreover, according to Document 3 in which the tubular separation membrane is wetted by liquid before the leak inspection, it is necessary to remove the liquid from the tubular separation membrane (i.e., regenerate the tubular separation membrane) when using the tubular separation membrane after the leak inspection. However, if the liquid is adsorbed on the inside of the small pores of the tubular separation membrane, a relatively long time becomes necessary to perform processing for removing the liquid, and processing costs may increase. Besides, since there is a limit to improving the efficiency of the liquid removal processing (i.e., improving the efficiency of regeneration), the tubular separation membrane may have degraded separation performance after the leak inspection.

### SUMMARY OF THE INVENTION

The present invention is intended for a method of evaluating a separation membrane module, and it is an object of the present invention to accurately evaluate characteristics of the separation membrane module.

A method of evaluating a separation membrane module according to one embodiment of the present invention includes a) supplying a performance degradation gas to a primary side of a separation membrane, the performance degradation gas having a property of reducing permeance of the separation membrane, and b) after the operation a), supplying an evaluation fluid to the primary side of the separation membrane and measuring a flow rate of the evaluation fluid to a secondary side of the separation membrane.

According to the present invention, it is possible to accurately evaluate characteristics of the separation membrane module.

Preferably, a rate of reduction of the permeance of the separation membrane before and after the operation a) may be higher than or equal to 30%.

Preferably, the evaluation fluid may have a molecular size of less than or equal to 0.40 nm.

Preferably, the evaluation fluid may have a molecular size that is 1.06 times or less of a pore size of the separation membrane.

Preferably, the separation membrane may be an inorganic membrane.

More preferably, the separation membrane may be a zeolite membrane.

Yet more preferably, the separation membrane may be composed of a maximum 8 or less-membered ring zeolite.

Preferably, the evaluation fluid and the performance degradation gas may be composed of an identical component.

Preferably, the performance degradation gas may contain at least one of water or organic matter.

Preferably, a difference in pressure between the primary side and secondary side of the separation membrane in the operation b) may be greater than or equal to 0.1 MPa.

Preferably, the method of evaluating a separation membrane module described above may further include, after the operation b), regenerating the separation membrane by recovering the permeance of the separation membrane that has been reduced by the performance degradation gas.

Preferably, the performance degradation gas may contain a total of 0.05 mol % or higher of a component whose boiling point under atmospheric pressure is higher than or equal to −10° C.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a separation membrane complex according to one embodiment.

FIG. 2 is a sectional view showing part of the separation membrane complex in enlarged dimensions.

FIG. 3 shows a separation apparatus.

FIG. 4 is a flowchart of processing for separating a mixed gas.

FIG. 5 is a flowchart of processing for evaluating characteristics of a separation membrane module.

### DETAILED DESCRIPTION

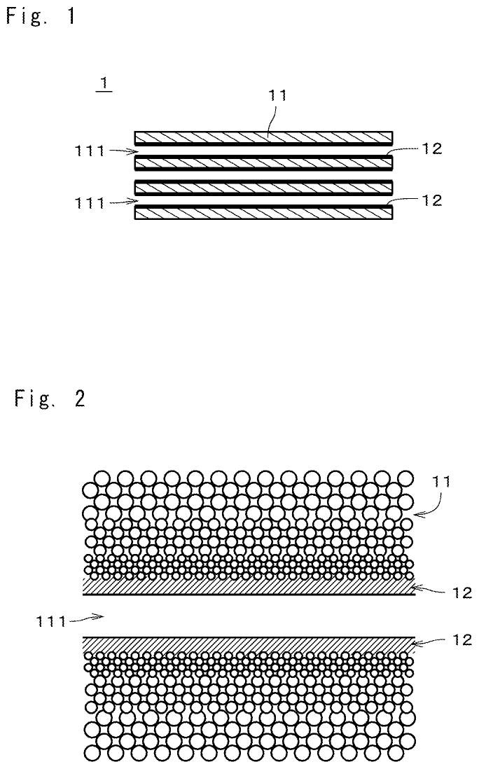

FIG. 1 is a sectional view of a separation membrane complex 1 that is part of a separation membrane module according to one embodiment of the present invention. FIG. 2 is a sectional view showing part of the separation membrane complex 1 in enlarged dimensions. The separation membrane complex 1 includes a support 11 and a separation membrane 12. In FIG. 1, the separation membrane 12 is illustrated with thick lines. In FIG. 2, the separation membrane 12 is hatched, and the thickness of the separation membrane 12 is illustrated greater than the actual thickness of the separation membrane.

The support 11 is a porous member that is permeable to gas and liquid. In the example illustrated in FIG. 1, the support 11 is an integrally-molded approximately-column-like member. The support 11 has a plurality of through holes 111 each extending in the longitudinal direction of the support. That is, the support 11 is a so-called monolith member. The support 11 may have, for example, an approximately column-like outside shape. Each through hole 111 (i.e., cell) may have an approximately circular section perpendicular to the longitudinal direction. In FIG. 1, the diameter of the through holes 111 is illustrated greater than the actual diameter of the through holes, and the number of through holes 111 is illustrated smaller than the actual number of through holes.

The length of the support 11 (i.e., the length in the right-left direction in FIG. 1) may be in the range of, for example, 10 cm to 200 cm. The outside diameter of the support 11 may be in the range of, for example, 0.5 cm to 30 cm. The distance between the central axis of each pair of adjacent through holes 111 may be in the range of, for example, 0.3 mm to 10 mm. The surface roughness (Ra) of the support 11 may be in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the thickness of the support 11 may be in the range of, for example, 0.1 mm to 10 mm.

The material for the support 11 may be any of various substances (e.g., ceramic or metal) as long as the substance has chemical stability during the process of forming the separation membrane 12 on the surface. In the present embodiment, the support 11 is formed of a ceramic sintered body. Examples of the ceramic sintered body selected as the material for the support 11 include alumina, silica, mullite, zirconia, titania, yttria, silicon nitride, and silicon carbide. In the present embodiment, the support 11 contains at least one kind of substances selected from the group consisting of alumina, silica, and mullite.

The support 11 may contain an inorganic binding material. The inorganic binding material may, for example, be at least one selected from the group consisting of titania, mullite, easily sinterable alumina, silica, glass frit, clay minerals, and easily sinterable cordierite.

The support 11 may have a mean pore size of, for example, 0.01 μm to 70 μm and preferably 0.05 μm to 25 μm. The mean pore size of the support 11 in the vicinity of the surface on which the separation membrane 12 is formed may be in the range of 0.01 μm to 1 μm and preferably in the range of 0.05 μm to 0.5 μm. The mean pore size may be measured by, for example, a mercury porosimeter, a perm-porometer, or a nano-perm-porometer. Referring to the pore size distribution of the support 11 as a whole including the surface and interior of the support 11, D5 may be in the range of, for example, 0.01 μm to 50 μm, D50 may be in the range of, for example, 0.05 μm to 70 μm, and D95 may be in the range of, for example, 0.1 μm to 2000 μm. The porosity of the support 11 in the vicinity of the surface on which the separation membrane 12 is formed may be in the range of, for example, 20% to 60%.

For example, the support 11 may have a multilayer structure in which a plurality of layers having different mean pore sizes are laminated one above another in the thickness direction. The mean pore size and sintered particle size of a surface layer that includes the surface on which the separation membrane 12 is formed are smaller than those of layers other than the surface layer. The mean pore size of the surface layer of the support 11 may be in the range of, for example, 0.01 μm to 1 μm and preferably in the range of 0.05 μm to 0.5 μm. In the case where the support 11 has a multilayer structure, the material for each layer may be any of the substances described above. The layers configuring the multilayer structure may be formed of the same material, or may be formed of different materials.

The separation membrane 12 is an approximately cylinder-like thin membrane provided on approximately the entire inside surfaces of the through holes 111 of the support 11. The separation membrane 12 is a dense porous membrane with micropores. The separation membrane 12 allows a specific substance to be separated from a mixture of substances including a plurality of kinds of substances by a molecular-sieving function.

The separation membrane 12 may, for example, be an inorganic membrane and preferably a zeolite membrane. The zeolite membrane refers to at least a membrane in which a zeolite is formed in membrane form on the surface of the support 11, and does not refer to a membrane in which zeolite particles are merely dispersed in an organic membrane. As described above, the zeolite membrane can be used as a separation membrane for separating a specific substance from a mixture of substances. The zeolite membrane is less permeable to substances other than the specific substance. In other words, the permeance of the zeolite membrane to the other substances is lower than the permeance of the zeolite membrane to the aforementioned specific substance. Note that the zeolite membrane may contain two or more types of zeolites having different structures or compositions.

The thickness of the separation membrane 12 may be in the range of, for example, 0.05 μm to 30 μm, preferably in the range of 0.1 μm to 20 μm, and more preferably in the range of 0.5 μm to 10 μm. Increasing the thickness of the separation membrane 12 improves separation performance. Reducing the thickness of the separation membrane 12 increases permeance. The surface roughness (Ra) of the separation membrane 12 may, for example, be less than or equal to 5 μm, preferably less than or equal to 2 μm, more preferably less than or equal to 1 μm, and yet more preferably less than or equal to 0.5 μm.

The pore sizes of zeolite crystals contained in the separation membrane 12 (hereinafter, also simply referred to as the “pore sizes in the separation membrane 12”) are greater than or equal to 0.2 nm and less than or equal to 0.8 nm, more preferably greater than or equal to 0.3 nm and less than or equal to 0.7 nm, and yet more preferably greater than or equal to 0.3 nm and less than or equal to 0.45 nm. In the case where the pore sizes in the separation membrane 12 are less than nm, the amount of substances permeating through the separation membrane 12 may be reduced, and in the case where the pore sizes in the separation membrane 12 are greater than 0.8 nm, the separation membrane 12 may have insufficient substance selectivity. The pore sizes in the separation membrane 12 refer to the diameters (i.e., minor axis) of small pores of the zeolite crystals, which configure the separation membrane 12, in a direction approximately perpendicular to the maximum diameter of the small pores (i.e., the major axis that takes a maximum value for the distance between oxygen atoms). The pore sizes in the separation membrane 12 are smaller than the mean pore size in the surface of the support 11 on which the separation membrane 12 is formed.

In the case where the zeolite membrane 12 is composed of a maximum n-membered ring zeolite, the minor axis of n-numbered ring pores is assumed to be the pore size of the zeolite membrane 12. In the case where the zeolite has a plurality of types of n-membered ring pores where n is the same number, the minor axis of n-membered ring pores that have a largest minor axis is assumed to be the pore size of the zeolite membrane 12. Note that the n-membered ring refers to a portion in which the number of oxygen atoms constituting the framework of a pore is n and each oxygen atom is bonded to a T atom described later to form a cyclic structure. The n-membered ring also refers to a ring that forms a through hole (channel), and does not refer to a ring that fails to form a through hole. The n-membered ring pore refers to a small pore formed of an n-membered ring. From the viewpoint of improving selectivity, the zeolite membrane 12 described above may preferably contain a maximum 8- or less-membered ring zeolite (e.g., 6- or 8-membered ring zeolite).

The pore sizes in the separation membrane 12, which is the zeolite membrane, are uniquely determined by the framework structure of the zeolite and obtained from values disclosed in “Database of Zeolite Structures” [online], by International Zeolite Association, Internet <URL:http://www.iza-structure.org/databases/>.

There are no particular limitations on the type of the zeolite of the zeolite membrane 12, and examples of the zeolite include AEI-, AEN-, AFN-, AFV-, AFX-, BEA-, CHA-, DDR-, EM-, ETL-, FAU- (X-type, Y-type), GIS-, IHW-, LEV-, LTA-, LTJ-, MEL-, MFI-, MOR-, PAU-, RHO-, SOD-, and SAT-type zeolites. In the case where the zeolite is an 8-membered ring zeolite, examples of the zeolite include AEI-, AFN-, AFV-, AFX-, CHA-, DDR-, ERI-, ETL-, GIS-,IHW-, LEV-, LTA-, LTJ-, RHO-, and SAT-type zeolites.

The zeolite of the zeolite membrane 12 may contain, for example, aluminum (Al) as T atoms (i.e., atoms located in the center of an oxygen tetrahedron (TO₄) configuring the zeolite). The zeolite of the separation membrane 12 may, for example, be a zeolite that contains only silicon (Si) or Si and Al as T atoms, an AlPO-type zeolite that contains Al and phosphorus (P) as T atoms, an SAPO-type zeolite that contains Si, Al, and P as T atoms, an MAPSO-type zeolite that contains magnesium (Mg), Si, Al, and P as T atoms, or a ZnAPSO-type zeolite that contains zinc (Zn), Si, Al, and P as T atoms. Some of the T atoms may be replaced by other elements.

The zeolite membrane 12 may contain, for example, Si. For example, the zeolite membrane 12 may contain any two or more of substances selected from the group consisting of Si, Al, and P. The zeolite membrane 12 may contain alkali metal. Examples of the alkali metal include sodium (Na) and potassium (K). In the case where the zeolite membrane 12 contains Si atoms and Al atoms, the Si/Al ratio in the zeolite membrane 12 may, for example, be higher than or equal to one and lower than or equal to a hundred thousand. The Si/Al ratio refers to the molar ratio of the Si elements to the Al elements contained in the zeolite membrane 12. The Si/Al ratio may preferably be higher than or equal to 5, more preferably higher than or equal to 20, and yet more preferably higher than or equal to 100. A higher Si/Al ratio is more preferable. The Si/Al ratio in the zeolite membrane 12 can be adjusted by adjusting, for example, the compounding ratio of an Si source and an Al source in a starting material solution described later.

In the separation membrane complex 1, the separation membrane 12 may further include, in addition to the zeolite membrane, a membrane other than the zeolite membrane. Alternatively, the separation membrane 12 may be a membrane other than the zeolite membrane.

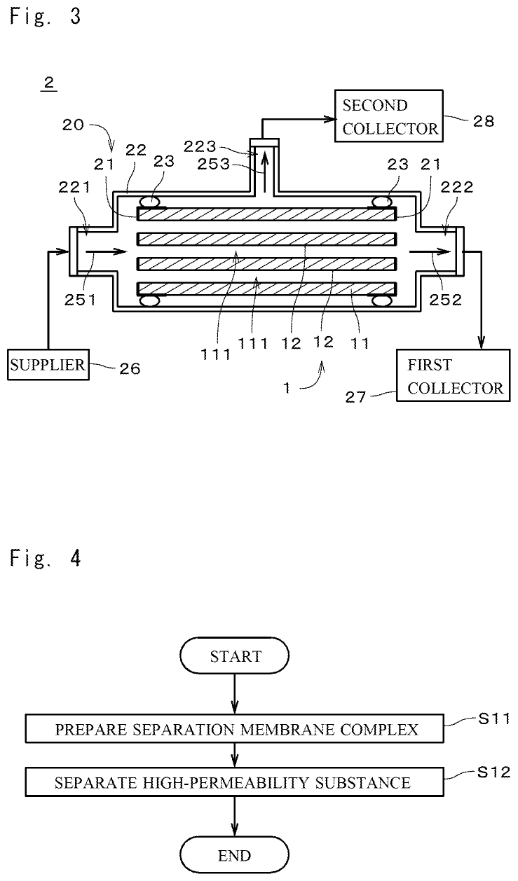

Next, the separation of a mixture of substances using the separation membrane complex 1 will be described with reference to FIGS. 3 and 4. FIG. 3 shows a separation apparatus 2. FIG. 4 is a flowchart of processing for separating a mixture of substances via the separation apparatus 2.

The separation apparatus 2 supplies a mixture of substances that include a plurality of types of fluids (i.e., gas or liquid) to the separation membrane complex 1 and separates a substance with high permeability in the mixture of substances from the mixture of substances by causing the substance to permeate through the separation membrane complex 1. For example, the separation by the separation apparatus 2 may be performed for the purpose of extracting a substance with high permeability (hereinafter, also referred to as a “high-permeability substance”) from the mixture of substances or for the purpose of condensing a substance with low permeability (hereinafter, referred to as a “low-permeability substance”).

The mixture of substances (i.e., a fluid mixture) may be a mixed gas that includes a plurality of types of gas, may be a mixed solution that includes a plurality of types of liquid, or may be a gas-liquid two-phase fluid that includes both gas and liquid.

The mixture of substances may include, for example, one or more kinds of substances selected from the group consisting of hydrogen (H₂), helium (He), nitrogen (N₂), oxygen (O₂), water (H₂O), water vapor (H₂O), carbon monoxide (CO), carbon dioxide (CO₂), nitrogen oxides, ammonia (NH₃), sulfur oxides, hydrogen sulfide (H₂S), sulfur fluorides, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The aforementioned high-permeability substance may, for example, be one or more kinds of substances selected from the group consisting of H₂, N₂, O₂, H₂O, CO₂, and H₂S.

Nitrogen oxides are compounds of nitrogen and oxygen. For example, the aforementioned nitrogen oxides may be gas called NOx such as nitrogen monoxide (NO), nitrogen dioxide (NO₂), nitrous oxide (also referred to as dinitrogen monoxide) (N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be gas called SOX such as sulfur dioxide (SO₂) or sulfur trioxide (SO₃).

Sulfur fluorides are compounds of fluorine and sulfur. For example, the aforementioned sulfur fluorides may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either of a saturated hydrocarbon (i.e., where double bonds and triple bonds are not located in molecules) and an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂═C(CH₃)₂).

The aforementioned organic acid may, for example, be carboxylic acid or sulfonic acid. The carboxylic acid may, for example, be formic acid (CH₂O₂), acetic acid (C₂H₄O₂), oxalic acid (C₂H₂O₄), acrylic acid (C3H₄O₂), or benzoic acid (C₆H₅COOH). The sulfonic acid may, for example, be ethane sulfonic acid (C2H₆O₃S). The organic acid may be a chain compound, or may be a cyclic compound.

The aforementioned alcohol may, for example, be methanol (CH₃OH), ethanol (C2H₅OH), isopropanol (2-propanol) (CH₃CH(OH)CH₃), ethylene glycol (CH₂(OH)CH₂(OH)), or butanol (C₄H₉OH).

Mercaptans are organic compounds with terminal sulfur hydrides (SH) and are also substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), or diethyl ether ((C₂H₅)₂O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H₇CHO).

The following description is given on the assumption that a mixture of substances to be separated by the separation apparatus 2 is a mixed gas that includes a plurality of types of gas.

The separation apparatus 2 includes a separation membrane module 20, a supplier 26, a first collector 27, and a second collector 28. The separation membrane module 20 includes a separation membrane complex 1, a sealer 21, a housing 22, and two seal members 23. The separation membrane complex 1, the sealer 21, and the seal members 23 are placed in the housing 22. The supplier 26, the first collector 27, and the second collector 28 are arranged outside the housing 22 and connected to the housing 22.

The sealer 21 is a member that is attached to both ends in the longitudinal direction (i.e., the left-right direction in FIG. 3) of the support 11 to cover and seal both end faces of the support 11 in the longitudinal direction and the outside surface of the support 11 in the vicinity of the both end faces. The sealer 21 prevents the inflow and outflow of gas and liquid from the both end faces of the support 11. For example, the sealer 21 may be a plate-like or membranous member formed of glass or resin. The material and shape of the sealer 21 may be appropriately changed. Note that the sealer 21 has a plurality of openings that overlap with the plurality of through holes 111 of the support 11. Thus, the both ends of each through hole 111 of the support 11 in the longitudinal direction are not covered with the sealer 21. This allows the inflow and outflow of gas and liquid from the both ends of each through hole 111 into and out of the through hole.

There are no particular limitations on the shape of the housing 22, and the housing 22 may, for example, be an approximately cylinder-like tubular member. For example, the housing 22 may be formed of stainless steel or carbon steel. The longitudinal direction of the housing 22 is approximately parallel to the longitudinal direction of the separation membrane complex 1. One end in the longitudinal direction of the housing 22 (i.e., the end on the left side in FIG. 3) is provided with a supply port 221, and the other end thereof is provided with a first exhaust port 222. The side face of the housing 22 is provided with a second exhaust port 223. The supply port 221 is connected to the supplier 26. The first exhaust port 222 is connected to the first collector 27. The second exhaust port 223 is connected to the second collector 28. The internal space of the housing 22 is an enclosed space isolated from the space around the housing 22.

The two seal members 23 are arranged around the entire circumference between the outside surface of the separation membrane complex 1 and the inside surface of the housing 22 in the vicinity of the both ends in the longitudinal direction of the separation membrane complex 1. Each seal member 23 is an approximately ring-shaped member formed of a material that is impermeable to gas and liquid. For example, the seal members 23 may be O-rings formed of resin having flexibility. The seal members 23 are in tight contact with the outside surface of the separation membrane complex 1 and the inside surface of the housing 22 along the entire circumference. In the example illustrated in FIG. 3, the seal members 23 are in tight contact with the outside surface of the sealer 21 and in indirect tight contact with the outside surface of the separation membrane complex 1 via the sealer 21. A space between the seal members 23 and the outside surface of the separation membrane complex 1 and a space between the seal members 23 and the inside surface of the housing 22 are sealed so as to almost or completely disable the passage of gas and liquid.

The supplier 26 supplies a mixed gas to the internal space of the outer cylinder 22 via the supply port 221. The supplier 26 may include, for example, a pressure mechanism such as a blower or pump that pumps the mixed gas toward the outer cylinder 22. The pressure mechanism may include, for example, a temperature regulator and a pressure regulator that respectively control the temperature and pressure of the mixed gas to be supplied to the outer cylinder 22. The first collector 27 and the second collector 28 may include, for example, a reservoir that stores gas delivered from the outer cylinder 22, or a blower or pump that transfers the gas.

In the separation of a mixed gas, first, the separation membrane complex 1 is prepared (step S11 in FIG. 4). Specifically, the separation membrane complex 1 is mounted on the inside of the outer cylinder 22. Then, the mixed gas including a plurality of types of gas to which the zeolite membrane 12 has different permeability is supplied from the supplier 26 to the inside of the outer cylinder 22 as indicated by an arrow 251. For example, the mixed gas may be composed primarily of CO₂ and CH₄. The mixed gas may also include gas other than CO₂ and CH₄. The pressure of the mixed gas supplied from the supplier 26 to the inside of the outer cylinder 22 (i.e., feed pressure that is the pressure on the primary side of the separation membrane 12) may be in the range of, for example, 0.1 MPaG to 20.0 MPaG. The temperature of the mixed gas supplied from the supplier 26 may be in the range of, for example, 10° C. to 250° C.

The mixed gas supplied from the supplier 26 to the outer cylinder 22 is introduced from the left end of the separating membrane complex 1 in the drawing into each through hole 111 of the support 11. A high-permeability substance that is gas with high permeability in the mixed gas permeates through the separation membrane 12 provided on the inside surface of each through hole 111 and the support 11 and is derived out from the outside surface of the support 11. Accordingly, the high-permeability substance (e.g., CO₂) is separated from a low-permeability substance (e.g., CH₄) that is gas with low permeability in the mixed gas (step S12).

The gas derived from the outside surface of the support 11 (hereinafter, also referred to as the “permeated substance”) is guided to the second collector 28 via the second exhaust port 223 as indicated by an arrow 253 and collected by the second collector 28. The pressure of the gas collected by the second collector 28 (i.e., permeate pressure that is the pressure on the secondary side of the separation membrane 12) may, for example, be 0.0 MPaG. In other words, the difference between the feed pressure and the permeate pressure may be in the range of, for example, 0.1 MPa to 20.0 MPa. The permeated substance may further include, in addition to the aforementioned high-permeability substance, a low-permeability substance that has permeated through the separation membrane 12.

In the mixed gas, gas other than substances that have permeated through the separation membrane 12 and the support 11 (hereinafter, also referred to as a “non-permeated substance”) passes through each through hole 111 of the support 11 from the left side to the right side in the drawing and collected by the first collector 27 via the first exhaust port 222 as indicated by an arrow 252. The pressure of the gas collected by the first collector 27 may, for example, be approximately the same as the feed pressure. The non-permeated substance may further include, in addition to the aforementioned low-permeability substance, a high-permeability substance that has not permeated through the separation membrane 12. For example, the non-permeated substance collected by the first collector 27 may be circulated by the supplier 26 and supplied again to the inside of the housing 22.

Next, an evaluation method for evaluating characteristics of the separation membrane module 20 will be described. As described above, the characteristics of the separation membrane module 20 are determined by, for example, performance of the separation membrane 12 (e.g., the permeance of a high-permeability substance) and the amount of leak from defects existing in the separation membrane 12 or the seal members 23 that provide sealing between the separation membrane complex 1 and the housing 22. The amount of leak refers to the amount of the mixed gas collected by the second collector 28 through detects such as micro-interstices between the seal members 23 and the separation membrane complex 1 and/or the housing 22 and defects such as cracks or delamination in the separation membrane 12. The mixed gas that has permeated through the defects leaks out to the space on the secondary side of the separation membrane 12 (i.e., the space on the permeate side) without permeating through small pores of the separation membrane 12 and is thus not separated by the separation membrane 12. The second collector 28 collects both a permeated substance that has permeated through the small pores of the separation membrane 12 (i.e., separated by the separation membrane 12) and the mixed gas that has leaked out from the defects existing in the separation membrane module 20.

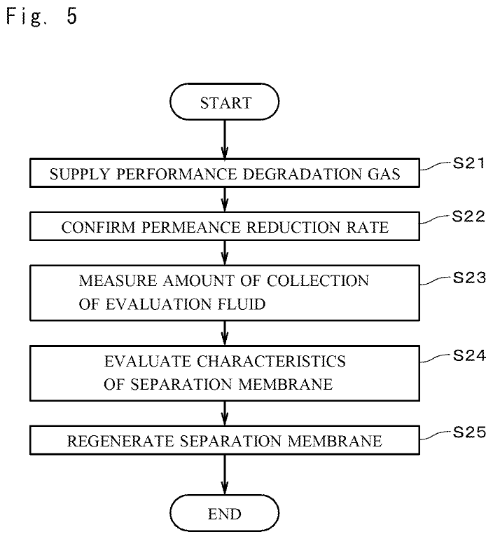

FIG. 5 is a flowchart of processing for evaluating the characteristics of the separation membrane module 20. The evaluation of the characteristics of the separation membrane module 20 is conducted using the above-described separation apparatus 2 shown in FIG. 3. In the evaluation of the separation membrane 12, first, a performance degradation gas having the property of reducing the permeance of the separation membrane 12 is supplied from the supplier 26 of the separation apparatus 2 to the inside of the housing 22 as indicated by the arrow 251. The performance degradation gas supplied from the supplier 26 to the housing 22 is introduced into each through hole 111 of the support 11 (i.e., to the primary side of the separation membrane 12) and adsorbs on the small pores of the separation membrane 12 (e.g., areas in the vicinity of the inlets of the small pores on the primary side of the separation membrane 12) (step S21). The performance degradation gas adsorbing on the small pores of the separation membrane 12 blocks part or the whole of the small pores. This inhibits the passage of an evaluation fluid or the like, which will be described later, through the small pores of the separation membrane 12. In step S21, the performance degradation gas is supplied for a predetermined period of time to the primary side of the separation membrane 12.

The performance degradation gas may be gas composed of one kind of substance, or may be a mixed gas that contains two or more kinds of substances. The performance degradation gas may contain, for example, at least one of water or organic matter. For example, the performance degradation gas may be N₂ gas that contains water vapor (i.e., unsaturated water vapor) whose content is less than the saturated water vapor content, or may be air that contains unsaturated water vapor. The performance degradation gas may also be air that contains vapor of a volatile organic compound whose content is less than the saturated vapor content (hereinafter, also referred to as an “unsaturated volatile organic compound (VOC)”). The performance degradation gas may also be a mixed gas that contains CH₄ and alcohol vapor. It is preferable that the performance degradation gas contains a component whose boiling point under atmospheric pressure is higher than or equal to −10° C. In this case, it is possible to efficiently block the small pores of the separation membrane 12. It is also preferable that a total concentration of components whose boiling points under atmospheric pressures are higher than or equal to −10° C. in the performance degradation gas is higher than or equal to 0.05 mol %. In this case, it is possible to more efficiently block the small pores of the separation membrane 12. There are no particular limitations on the upper limit for the total concentration of components whose boiling points under atmospheric pressure are higher than or equal to −10° C. in the performance degradation gas as long as these components are unsaturated. However, it is preferable that the total concentration is usually lower than or equal to 90 mol % in consideration of easiness of processing for regenerating the separation membrane 12, which will be described later.

In the evaluation of the characteristics of the separation membrane module 20, gas that contains droplets is not used as the performance degradation gas. If gas that contains droplets is used as the performance degradation gas, the processing for regenerating the separation membrane 12 described later requires a long time to remove liquid that adsorbs on the small pores of the separation membrane 12. This may increase the cost of processing and may degrade the separation performance of the separation membrane 12 after the regeneration processing. Besides, in the evaluation of the characteristics of the separation membrane module 20, which will be described later, the liquid may temporarily block defects in the seal members 23 or the separation membrane 12 and may cause degradation in the accuracy of evaluation. For similar reasons, liquid and gas that contain saturated vapor are not used as the performance degradation gas.

When step S21 has completed, the rate of reduction of the permeance of the separation membrane 12 caused by the performance degradation gas is checked (step S22). In step S22, for example, a permeance measurement fluid for measuring the rate of reduction of the permeance of the separation membrane 12 is supplied from the supplier 26 to the inside of the housing 22 and introduced into each through hole 111 of the support 11 (i.e., to the primary side of the separation membrane 12). Part of the permeance measurement fluid permeates through the separation membrane 12 and the support 11 and is collected by the second collector 28. Then, the amount of collection of the permeance measurement fluid collected by the second collector 28 (i.e., the amount of the permeance measurement fluid that has moved to the secondary side of the separation membrane 12) is compared with the amount of collection of the permeance measurement fluid acquired in advance before step S21 by measurement similar to the measurement conducted in step S22 (i.e., the amount of collection measured before the degradation of performance caused by the performance degradation gas) so as to check the permeance reduction rate before and after step S22. The permeance reduction rate is obtained by dividing the amount of collection of the permeance measurement fluid collected after the degradation of performance caused by the performance degradation gas by the amount of collection of the permeance measurement fluid before the degradation of performance and subtracting the value obtained by the division from one. For example, the permeance reduction rate may be higher than or equal to 30%, preferably higher than or equal 50%, and more preferably higher than or equal to 60%.

The permeance measurement fluid may be a fluid composed of one kind of substance, or may be a fluid mixture that contains two or more kinds of substances. The permeance measurement fluid may be gas, liquid, or a gas-liquid two-phase fluid. For example, the permeance measurement fluid may be an inorganic gas such as N₂ gas or CO₂ gas. Alternatively, like the performance degradation gas, the permeance measurement fluid may contain at least one of water or organic matter. The permeance measurement fluid may be liquid water. The permeance measurement fluid may also be N₂ gas that contains saturated water vapor, or may be air that contains saturated water vapor. The permeance measurement fluid may also be a mixed gas that contains CH₄ and water vapor. As another alternative, the permeance measurement fluid may be a gas-liquid two-phase fluid that contains CO₂ gas or air and HC droplets, or may be a mixed gas that contains CO₂ gas and alcohol vapor. The permeance measurement fluid may also be gas composed of the same components as the performance degradation gas.

When step S22 has completed, an evaluation fluid for evaluating the characteristics of the separation membrane module 20 is supplied from the supplier 26 to the inside of the housing 22 and introduced into each through hole 111 of the support 11 (i.e., to the primary side of the separation membrane 12). Part of the evaluation fluid permeates through the separation membrane 12 and the support 11 and is collected by the second collector 28. Another part of the evaluation fluid permeates through defects existing in the seal members 23 and the separation membrane 12 and is collected by the second collector 28. Then, the amount of collection of the evaluation fluid collected by the second collector 28 (i.e., the flow rate of the evaluation fluid to the secondary side of the separation membrane 12) is measured (step S23). In step S23, for example, a difference between the feed pressure and the permeate pressure, i.e., an evaluation pressure difference, may be greater than or equal to 0.1 MPa. Preferably, the evaluation pressure difference may be greater than or equal to 0.5 MPa, and more preferably greater than or equal to 1.0 MPa.

As described above, since the passage of the evaluation fluid through the separation membrane 12 is inhibited by the performance degradation gas, the ratio of the evaluation fluid that has permeated through the aforementioned defects in the evaluation fluid collected by the second collector 28 becomes higher than in the case where the reduction in permeance is not caused by the performance degradation gas. This makes clear the difference in the amount of collection of the evaluation fluid depending on the presence or absence of the aforementioned defects.

The evaluation fluid may be a fluid composed of one kind of substance, or may be a fluid mixture that contains two or more kinds of substances. The evaluation fluid may be gas, liquid, or a gas-liquid two-phase fluid. For example, the evaluation fluid may be an inorganic gas such as N₂ gas or CO₂ gas. Alternatively, the evaluation fluid may contain the performance degradation gas.

The evaluation fluid may have a molecular size greater than the molecular size of the permeance measurement fluid. Thus, the rate of reduction of the permeance of the separation membrane 12 to the evaluation fluid, caused by the performance degradation gas, is higher than the rate of reduction of the permeance to the permeance measurement fluid measured in step S22. This makes clearer the difference in the amount of collection of the evaluation fluid depending on the presence or absence of the aforementioned defects.

The molecular size of the evaluation fluid as used herein refers to the molecular size of a substance that has a smallest molecular size out of remaining substances (hereinafter, also referred to as “molecular-size evaluation substances”) obtained by excluding substances whose contents in the evaluation fluid are less than or equal to 10% by volume from among the substances contained in the evaluation fluid. In the case where the evaluation fluid is a gas-liquid two-phase fluid, the molecular-size evaluation substances are remaining substances obtained by excluding liquid substances and the aforementioned substances whose contents in the evaluation fluid are less than or equal to 10% by volume from among the substances contained in the evaluation fluid. For example, in the case where the evaluation fluid is a fluid mixture that contains 2% by volume of water vapor and 98% by volume of air, O₂ and N₂ in the air other than the water vapor whose content in the evaluation fluid is less than 10% by volume become the molecular-size evaluation substances. Then, out of O₂ (with a molecular size of 0.35 nm) and N₂ (with a molecular size of 0.36 nm), the molecular size of O₂ having a smaller molecular size, i.e., 0.35 nm, is assumed to be the molecular size of the evaluation fluid. In the case where the evaluation fluid is a gas-liquid two-phase fluid that contains air and HC droplets, the molecular size of O₂ having a smaller molecular size, i.e., 0.35 nm, out of O₂ and N₂ in the air other than the liquid HC, is assumed to be the molecular size of the evaluation fluid. The same description about the molecular size of the evaluation fluid applies to the molecular size of the permeance measurement fluid.

For example, the molecular size of the evaluation fluid may be less than or equal to 0.40 nm. In this case, even if relatively small defects exist in the seal members 23 or the separation membrane 12, it is possible to more easily determine the presence or absence of the defects because the evaluation fluid permeates through these defects and is collected by the second collector 28. In the case where the evaluation fluid is a fluid mixture that contains a plurality of types of molecular-size evaluation substances, it is preferable that a total of the contents of substances whose molecular sizes are less than or equal to 0.40 nm, among all the molecular-size evaluation substances in the fluid, is higher than or equal to 80% by volume.

For example, the molecular size of the evaluation fluid may also be 1.06 times or less of the pore size of the separation membrane 12. In this case, even if relatively small defects having sizes comparable to or smaller than the pore size of the separation membrane 12 exist in the seal members 23 or the separation membrane 12, it is possible to more easily determine the presence or absence of the defects because the evaluation fluid permeates through these defects and is collected by the second collector 28. In the case where the evaluation fluid is a fluid mixture that contains a plurality of types of molecular-size evaluation substances, it is preferable that a total of the contents of substances whose molecular sizes are 1.06 times or less of the pore size of the separation membrane 12, among all the molecular-size evaluation substances in the fluid, is higher than or equal to 70% by volume. If the separation membrane 12 according to the present application is not a zeolite membrane, the pore size of the separation membrane 12 refers to the mean pore size of the separation membrane 12.

The amount of collection of the evaluation fluid measured in step S23 (hereinafter, also referred to as the “measured collection amount”) is compared with a reference collection amount to evaluate the characteristics of the separation membrane module 20 (step S24). The reference collection amount may be arbitrarily set depending on factors such as the performance of the separation membrane 12 or specifications required for the separation membrane module 20. For example, the reference collection amount may be set to a value obtained by multiplying an allowable amount of leak of the evaluation fluid (i.e., the amount of leak of the evaluation fluid that does not permeate through the small pores of the separation membrane 12) by a constant coefficient.

In step S24, if the measured collection amount of the evaluation fluid is less than or equal to the reference collection amount, the separation membrane module 20 is determined to be in good condition because there is a small amount of leak of the evaluation fluid from the aforementioned defects in the separation membrane module 20 (i.e., a small amount of leak of the evaluation fluid that does not permeate through the small pores of the separation membrane 12). On the other hand, if the measured collection amount of the evaluation fluid is greater than the reference collection amount, the separation membrane module 20 is determined to be in bad condition because there is a great amount of leak of the evaluation fluid in the separation membrane module 20. In the case where the separation membrane module 20 is determined to be in bad condition, the separation membrane module 20 may, for example, be repaired (i.e., the seal members 23 may be replaced or cracks in the separation membrane 12 may be repaired).

When the evaluation of the characteristics of the separation membrane module 20 has completed, the separation membrane 12 is regenerated by recovering the permeance of the separation membrane 12 that has been reduced by the performance degradation gas (step S25). Specifically, for example, the performance degradation gas adsorbed on the small pores of the separation membrane 12 is removed by heating the separation membrane complex 1. As described above, since the performance degradation gas is either gas that substantially does not contain vapor or gas that contains unsaturated vapor (i.e., vapor whose content is less than the saturated vapor content), it is possible to easily remove the performance degradation gas from the small pores of the separation membrane 12. The heating of the separation membrane complex 1 may be conducted by, for example, supplying high-temperature dry air from the supplier 26 to the inside of the housing 22. For example, the dry air may have a moisture content of less than or equal to 300 ppm. Thereafter, the separation membrane module 20 including the regenerated separation membrane 12 is used for the aforementioned processing such as the separation of the mixed gas (step S12).

Note that steps S21 to S25 described above may be performed in the midstream of processing such as the separation of the mixed gas via the separation membrane module 20. In this case, it is possible to detect, for example, degradation in characteristics due to a change of the separation membrane module 20 with the passage of time.

In step S22 described above, as long as the confirmation of the permeance reduction rate is possible, it is not always necessary to supply the permeance measurement fluid to the separation membrane 12 and measure the amount of collection by the second collector 28 after step S21. For example, in the case where information such as a relationship between the permeance reduction rate of the separation membrane 12 and the type of the performance degradation gas supplied to the separation membrane 12 is measured and stored in advance, the confirmation of the permeance reduction rate in step S22 may be conducted by extracting the permeance reduction rate that corresponds to the performance degradation gas used in step S21 from the stored information (hereinafter, also referred to as “performance-degradation-gas and reduction-rate information”). Note that the performance-degradation-gas and reduction-rate information may include a plurality of permeance reduction rates for each performance degradation gas, the permeance reduction rates corresponding to cases such as where the duration of time of supply to the separation membrane 12 is changed or where the contents of components are changed.

Next, examples and comparative examples for the evaluation of the characteristics of the separation membrane module 20 will be described with reference to Table 1. In Examples 1 to 7, different values were used for the type of the performance degradation gas supplied to the separation membrane 12 in step S21, the permeance reduction rate caused by the performance degradation gas, the type of the evaluation fluid supplied to the separation membrane 12 in step S23, and the evaluation pressure difference that was the difference between the feed pressure and the permeate pressure in step S23. In Examples 1 to 7, the total concentration of components that were contained in the performance degradation gas and whose boiling points under atmospheric pressure were higher than or equal to −10° C. was in the range of 0.05 mol % to 90 mol %. In Comparative Example 1, the supply of the performance degradation gas in step S21 was omitted. In Comparative Example 2, a liquid organic solvent was supplied, instead of the performance degradation gas, in step S21. In Examples 1 to 7 and Comparative Examples 1 and 2, steps S21 to S24 described above were performed on the separation membrane module 20 that was proved in advance in good conditions (i.e., with a small amount of leak from defects). Then, in the “Evaluation” column, evaluations were made about to what extent the aforementioned measurement conditions including the type of the performance degradation gas, the permeance reduction rate, the type of the evaluation fluid, and the evaluation pressure difference were suitable for the evaluation of the characteristics of the separation membrane module 20.

TABLE 1

| | Performance | Performance | | Evaluation | |
|---|---|---|---|---|---|
| | Degradation | Degradation | | Pressure | |
| | Agent | Rate | Evaluation Gas | Difference | Evaluation |
| Example 1 | Air + | 80% | Air | 1.0 MPa | ⊚ |
| | VOC vapor | | | | |
| Example 2 | CO₂ + | 80% | CO₂ + | 1.0 MPa | ⊚ |
| | VOC vapor | | VOC vapor | | |
| Example 3 | CO₂ + | 80% | CO₂ + | 0.5 MPa | ◯ |
| | VOC vapor | | VOC vapor | | |
| Example 4 | CO₂ + | 80% | CO₂ + | 0.1 MPa | Δ |
| | VOC vapor | | VOC vapor | | |
| Example 5 | N₂ + | 30% | N₂ + | 4.0 MPa | Δ |
| | water vapor | | water vapor | | |
| Example 6 | N₂ + | 50% | N₂ + | 4.0 MPa | ◯ |
| | water vapor | | water vapor | | |
| Example 7 | CH₄ + | 70% | CH₄ + | 1.0 MPa | ⊚ |
| | alcohol vapor | | alcohol vapor | | |
| Comparative | — | 0% | N₂ | 1.0 MPa | X |
| Example 1 | | | | | |
| Comparative | Liquid organic | 95% | N₂ | 1.0 MPa | X |
| Example 2 | solvent | | | | |

In Examples 1 to 7 and Comparative Examples 1 and 2, the separation membrane 12 was a DDR-type zeolite membrane. The zeolite of the separation membrane 12 had an intrinsic pore size of 0.36 nm×0.44 nm, and the pore size of the separation membrane 12 (i.e., the minor axis of the zeolite) was 0.36 nm.

In Examples 1 to 7 and Comparative Examples 1 and 2, the separation membrane complex 1 was produced as described below. First, the support 11 was immersed in a solution obtained by dispersing seed crystals, so as to cause the seed crystals to adhere to the support 11. The seed crystals may be DDR-type zeolite powder generated by hydrothermal synthesis, or may be obtained by pulverizing the DDR-type zeolite powder. Note that any method other than the above-described method may be used to cause the seed crystals to adhere to the support 11. Then, the support 11 with the seed crystals adhering thereto was immersed in a starting material solution and subjected to hydrothermal synthesis. In this way, the DDR-type zeolite was grown using the seed crystals as nuclei so as to form the separation membrane 12, which was a DDR-type separation membrane, on the support 11. The starting material solution was prepared by, for example, dissolving an Si source and a structure-directing agent (hereinafter, also referred to as the “SDA”) in a solvent. The starting material solution had a composition of 1.0 SiO₂: 0.015 SDA: 0.12 (CH₂)₂(NH₂)₂. The solvent in the starting material solution was water, and the SDA contained in the starting material solution was 1-adamantanamine. The hydrothermal synthesis temperature was preferably in the range of 120 to 200° C. and may, for example, be 160° C. The hydrothermal synthesis time was preferably in the range of 10 to 100 hours and may, for example, be 30 hours. After the hydrothermal synthesis had completed, the support and the separation membrane 12 were washed and subjected to heat treatment so that the SDA in the separation membrane 12 was removed by combustion and penetrated microscopic pores to obtain the separation membrane complex 1 described above.

In Example 1, air that contained unsaturated VOC (i.e., VOC vapor whose content was less than the saturated vapor content) was used as the performance degradation gas in step S21.

As the VOC, isobutane and vinyl acetate were used. The permeance reduction rate was obtained at ambient temperature by using CO₂ gas as the permeance measurement fluid in step S22 and setting the feed pressure and the permeate pressure to 0.1 MPaG and atmospheric pressure, respectively. The permeance reduction rate was 80%. Then, the measured correction amount of the evaluation fluid was obtained by using air as the evaluation fluid in step S23 and setting the evaluation pressure difference, which was the difference between the feed pressure and the permeate pressure, to 1.0 MPa. The measurement conditions in Example 1 were evaluated as “double circle.”

In Table 1, the “double circle” symbol in the “Evaluation” column indicates that the measured collection amount was 40% or less of the reference collection amount and accordingly the measurement conditions were very suitable for the evaluation of the characteristics of the separation membrane module 20. The “circle” symbol in the “Evaluation” column indicates that the measured collection amount was more than 40% of and 50% or less of the reference collection amount and accordingly the measurement conditions were suitable for the evaluation of the characteristics of the separation membrane module 20. The “triangle” symbol in the “Evaluation” column indicates that the measured collection amount was greater than 50% and less than 100% of the reference collection amount and the measurement conditions were not suitable enough to be comparable to the measurement conditions indicated by the “double circle” and “circle” symbols, but were suitable to some extent for the evaluation of the characteristics of the separation membrane module 20. The “cross” symbol indicates that the measured collection amount was 100% or more of the reference collection amount and accordingly it was not possible to evaluate the characteristics of the separation membrane module 20 due to a high flow rate of the evaluation fluid permeating through the separation membrane 12. The cases indicated by the “cross” symbol also include such a case where the permeance of the separation membrane 12 was not recovered enough even by the regeneration of the separation membrane 12 in step S25.

Example 2 was the same as Example 1, except that CO₂ gas containing unsaturated VOC was used as the performance degradation gas and the evaluation fluid. The permeance reduction rate in Example 2 was 80%. Example 2 was evaluated as “double circle”, and the measurement conditions were very suitable for the evaluation of the characteristics of the separation membrane module 20.

Example 3 was the same as Example 2, except that the evaluation pressure difference was set to 0.5 MPa. The permeance reduction rate in Example 3 was 80%. Example 3 was evaluated as “circle”, and the measurement conditions were suitable for the evaluation of the characteristics of the separation membrane module 20.

Example 4 was the same as Example 2, except that the evaluation pressure difference was set to 0.1 MPa. The permeance reduction rate in Example 4 was 80%. Example 4 was evaluated as “triangle”, and the measurement conditions were suitable to some extent for the evaluation of the characteristics of the separation membrane module 20.

Example 5 was the same as Example 1, except that N₂ gas containing unsaturated water vapor was used as the performance degradation gas and the evaluation fluid and that the evaluation pressure difference was set to 4.0 MPa. The permeance reduction rate in Example 5 was 30%. Example 5 was evaluated as “triangle”, and the measurement conditions were suitable to some extent for the evaluation of the characteristics of the separation membrane module 20.

Example 6 was the same as Example 5, except that the water vapor content in the performance degradation gas was changed (specifically, the water vapor content was made higher than in Example 5 within the unsaturation range). The permeance reduction rate in Example 6 was 50%. Example 6 was evaluated as “circle”, and the measurement conditions were suitable for the evaluation of the characteristics of the separation membrane module 20.

Example 7 was the same as Example 1, except that the CH₄ gas containing alcohol vapor whose content was less than the saturated vapor content (specifically, ethanol vapor) was used as the performance degradation gas and the evaluation fluid. The permeance reduction rate in Example 7 was 70%. Example 7 was evaluated as “double circle”, and the measurement conditions were very suitable for the evaluation of the characteristics of the separation membrane module 20.

In Comparative Example 1, the permeance reduction rate was 0% because, as described above, the performance degradation gas was not supplied to the separation membrane 12. Although N₂ gas was used as the evaluation fluid and the same separation membrane module 20 as that in Example 1 (i.e., the separation membrane module 20 in good condition) was measured for the amount of collection of the evaluation fluid, the separation membrane module 20 was not determined to be in good condition because of a high flow rate of the evaluation fluid permeating through the separation membrane 12. That is, Comparative Example 1 was evaluated as “cross”.

Comparative Example 2 was the same as Comparative Example 1, except that a liquid organic solvent was supplied to the separation membrane 12, instead of the performance degradation gas. The permeance reduction rate was 95%. In Comparative Example 2, the permeance of the separation membrane 12 was not recovered enough even by the regeneration of the separation membrane 12 in step S25. Thus, Comparative Example 2 was evaluated as “cross”. Comparisons of Examples 2 to 4 show that increasing the evaluation pressure difference improves the results of evaluation of the measurement conditions. In this case, the evaluation pressure difference is preferably greater than or equal to 0.5 MPa and more preferably greater than or equal to 1.0 MPa. Comparisons of Examples 1 and 2 and Example 5 to 7 show that the permeance reduction rate is more preferably higher than or equal to 50% and yet more preferably higher than or equal to 70%.

As described above, the method of evaluating the separation membrane module 20 includes the step (step S21) of supplying the performance degradation gas having the property of reducing the permeance of the separation membrane 12 to the primary side of the separation membrane 12 and the step (step S23) of, after step S21, supplying the evaluation fluid to the primary side of the separation membrane 12 and measuring the flow rate of the evaluation fluid to the secondary side of the separation membrane 12.

Accordingly, the flow rate of the evaluation fluid permeating through the separation membrane 12 (i.e., permeating through the small pores of the separation membrane 12) is reduced in step S23. This increases the proportion of the evaluation fluid that has permeated through defects existing in, for example, the seal members 23 or the separation membrane 12 to the evaluation fluid collected by the second collector 28. As a result, the difference in the amount of collection of the evaluation fluid depending on the presence or absence of the aforementioned defects is made clear, and it is possible to accurately evaluate the characteristics of the separation membrane module 20.

Since the performance degradation gas inhibits the passage of the evaluation fluid through the separation membrane 12, the evaluation fluid does not necessarily have to be a fluid whose molecular size is greater than the pore size of the separation membrane 12 and that is less prone to permeate through the separation membrane 12. In other words, the degree of flexibility in selecting the evaluation fluid is improved more than in the case where the type of the evaluation fluid is limited by the molecular size. As a result, the discharge and collection of the evaluation fluid become easier than in the case where Fluorinert or the like described above has to be used as the evaluation fluid.

As described above, it is preferable that the permeance reduction rate of the separation membrane 12 before and after step S21 is higher than or equal to 30%. In this case, it is possible to favorably reduce the flow rate of the evaluation fluid permeating through the separation membrane 12 in step S23. As a result, the difference in the amount of collection of the evaluation fluid depending on the presence or absence of the aforementioned defects is made clear, and it is possible to more accurately evaluate the characteristics of the separation membrane module 20. As described above, it is preferable that the molecular size of the evaluation fluid is less than or equal to 0.40 nm. In this case, even if relatively small defects (e.g., defects with diameters of approximately 0.40 nm) exist in the seal members 23 or the separation membrane 12, the evaluation fluid permeates through these defects and is collected by the second collector 28. Accordingly, it is possible to more accurately evaluate the characteristics of the separation membrane module 20.

As described above, it is preferable that the molecular size of the evaluation fluid is 1.06 times or less of the pore size of the separation membrane 12. In this case, even if relatively small defects having sizes comparable to or smaller than the pore size of the separation membrane 12 exist in the seal members 23 or the separation membrane 12, the evaluation fluid permeates through these defects and is collected by the second collector 28. Accordingly, it is possible to more accurately evaluate the characteristics of the separation membrane module 20.

As described above, it is preferable that the separation membrane 12 is an inorganic membrane. In this case, it is possible to improve heat resistance and/or resistance to the organic solvent of the separation membrane module 20.

More preferably, the separation membrane 12 may be a zeolite membrane. If the separation membrane 12 is composed of zeolite crystals having a uniform pore size, it is possible to satisfactorily achieve selective permeation of the separation membrane 12 to a substance targeted for permeation. As a result, it is possible to efficiently separate the substance targeted for permeation from the mixture of substances.

Yet more preferably, the separation membrane 12 may be composed of a maximum 8 or less-membered ring zeolite. In this case, it is possible to satisfactorily achieve selective permeation of the separation membrane 12 to a substance targeted for permeation and having small molecular sizes, such as H₂ or CO₂, and to efficiently separate the substance targeted for permeation from the mixture of substances.

As described above, it is preferable that the evaluation fluid and the performance degradation gas are composed of the same components. In this case, it is possible to inhibit the performance degradation gas adsorbed on the small pores of the separation membrane 12 in step S21 from being desorbed from the small pores as a result of the supply of the evaluation fluid in step S23. In other words, it is possible to inhibit the small pores of the separation membrane 12 blocked by the performance degradation gas in step S21 from being opened due to the supply of the evaluation fluid in step S23. Besides, it is possible to simplify the evaluation of the characteristics of the separation membrane module 20 more than in the case where the performance degradation gas and the evaluation fluid are composed of different components.

As described above, it is preferable that the performance degradation gas contains at least one of water or organic matter. In this case, it is possible to satisfactorily reduce the permeance of the separation membrane 12 (i.e., increase the permeance reduction rate). Moreover, in the case of regenerating the separation membrane 12 in step S25, it is possible to easily remove the performance degradation gas from the separation membrane 12.

As described above, it is preferable that the difference in pressure between the primary side and secondary side of the separation membrane 12 in step S23 (i.e., the evaluation pressure difference) is greater than or equal to 0.1 MPa. In the separation membrane module 20, the permeance of the evaluation fluid permeating through the separation membrane 12 decreases with increasing evaluation pressure difference, but the permeance of the evaluation fluid permeating through the aforementioned defects remains almost unchanged. Therefore, if the evaluation pressure difference is set to be greater than or equal to 0.1 MPa, the difference in the amount of collection of the evaluation fluid depending on the presence or absence of the aforementioned defects becomes favorably clear, and it becomes possible to more accurately evaluate the characteristics of the separation membrane module 20. From the viewpoint of improving the accuracy of evaluating the characteristics of the separation membrane module 20, the evaluation pressure difference may be more preferably greater than or equal to 0.5 MPa and yet more preferably greater than or equal to 1.0 MPa.

As described above, it is preferable that the method of evaluating the separation membrane module 20 further includes the step (step S25) of, after step S23, regenerating the separation membrane 12 by recovering the permeance of the separation membrane 12 that has been reduced by the performance degradation gas. In this case, it is possible to favorably use the separation membrane module 20 that has undergone the evaluation of the characteristic, in processing such as the separation of the mixture of substances.

As described above, it is preferable that the performance degradation gas contains a total of 0.05 mol % or more of components whose boiling points under atmospheric pressure are higher than or equal to −10° C. In this case, it is possible to efficiently block the small pores of the separation membrane 12.

The method of evaluating the separation membrane module 20 described above may be modified in various ways.

For example, the performance degradation gas used in step S21 does not necessarily have to contain water or organic matter, and the performance degradation gas used in step S21 may contain neither water nor organic matter.

The permeance reduction rate of the separation membrane 12 before and after step S21 may be lower than 30%.

The components of the evaluation fluid used in step S23 may be different from or the same as the components of the performance degradation gas. The components of the permeance measurement fluid used in step S22 may also be different from or the same as the components of the performance degradation gas.

The molecular size of the evaluation fluid may be greater than 1.06 times of the pore size of the separation membrane 12. The molecular size of the evaluation fluid may also be greater than 0.40 nm. The molecular size of the evaluation fluid may also be smaller than the molecular size of the permeance measurement fluid.

The evaluation pressure difference in step S23 may be less than 0.1 MPa.

Depending on the type of the performance degradation gas or the usage of the separation apparatus 2 after the evaluation of the characteristics of the separation membrane module 20, step S25 may be omitted.

The separation membrane complex 1 may further include, in addition to the support 11 and the separation membrane 12, a functional membrane or a protection membrane that is laminated on the separation membrane 12. Such a functional membrane or a protection membrane may be an inorganic membrane such as a zeolite membrane, a silica membrane, or a carbon membrane, or may be an organic membrane such as a polyimide membrane or a silicone membrane.

The zeolite membrane 12 may be composed of a maximum 9 or more-membered ring zeolite. The separation membrane 12 may be an inorganic membrane other than a zeolite membrane, or may be an organic membrane.

The separation apparatus 2 described above may separate a substance other than those described above from a mixed gas. The structure of the separation apparatus 2 is also not limited to the example described above, and may be modified in various ways.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The present invention is applicable for processing such as evaluating a separation membrane module that is used for the separation or adsorption of various fluids.

### REFERENCE SIGNS LIST

12 separation membrane
20 separation membrane module
S11 to S12, S21 to S25 step

1. A method of evaluating a separation membrane module, comprising:
a) supplying a performance degradation gas to a primary side of a separation membrane, the performance degradation gas having a property of reducing permeance of said separation membrane; and
b) after said operation a), supplying an evaluation fluid to the primary side of said separation membrane and measuring a flow rate of said evaluation fluid to a secondary side of said separation membrane.

2. The method of evaluating a separation membrane module according to claim 1, wherein
a rate of reduction of the permeance of said separation membrane before and after said operation a) is higher than or equal to 30%.

3. The method of evaluating a separation membrane module according to claim 1, wherein
said evaluation fluid has a molecular size of less than or equal to 0.40 nm.

4. The method of evaluating a separation membrane module according to claim 1, wherein
said evaluation fluid has a molecular size that is 1.06 times or less of a pore size of said separation membrane.

5. The method of evaluating a separation membrane module according to claim 1, wherein
said separation membrane is an inorganic membrane.

6. The method of evaluating a separation membrane module according to claim 5, wherein
said separation membrane is a zeolite membrane.

7. The method of evaluating a separation membrane module according to claim 6, wherein
said separation membrane is composed of a maximum 8 or less-membered ring zeolite.

8. The method of evaluating a separation membrane module according to claim 1, wherein
said evaluation fluid and said performance degradation gas are composed of an identical component.

9. The method of evaluating a separation membrane module according to claim 1, wherein
said performance degradation gas contains at least one of water or organic matter.

10. The method of evaluating a separation membrane module according to claim 1, wherein
a difference in pressure between the primary side and secondary side of said separation membrane in said operation b) is greater than or equal to 0.1 MPa.

11. The method of evaluating a separation membrane module according to claim 1, further comprising:
after said operation b), regenerating said separation membrane by recovering the permeance of said separation membrane that has been reduced by said performance degradation gas.

12. The method of evaluating a separation membrane module according to claim 1, wherein
said performance degradation gas contains a total of 0.05 mol % or higher of a component whose boiling point under atmospheric pressure is higher than or equal to −10° C.
